(19) United States
(12) Patent Application Publication
(10) Pub. No.: US 2002/0145994 A1
(43) Pub. Date: Oct. 10, 2002

(54) Method of operating a radio-based telecommunications system

(75) Inventor: Ivar Mortensen, Stuttgart (DE)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/107,475

(22) Filed: Mar. 28, 2002

(30) Foreign Application Priority Data
Apr. 7, 2001 (DE) 101 17 628.7

(51) Int. Cl. H04B 7/212

(52) U.S. Cl. 370/347; 370/476

(57) ABSTRACT

A method is described for operating a radio-based telecommunications system, in particular a UMTS telecommunications system. The data to be transmitted are transmitted in data frames, so-called frames. A plurality of frames are combined to form a group. A format-related indicator is transmitted for each frame. A number of permissible format-related indicators is specified in advance. The number of permissible format-related indicators is reduced as a function of the combination of frames in groups.

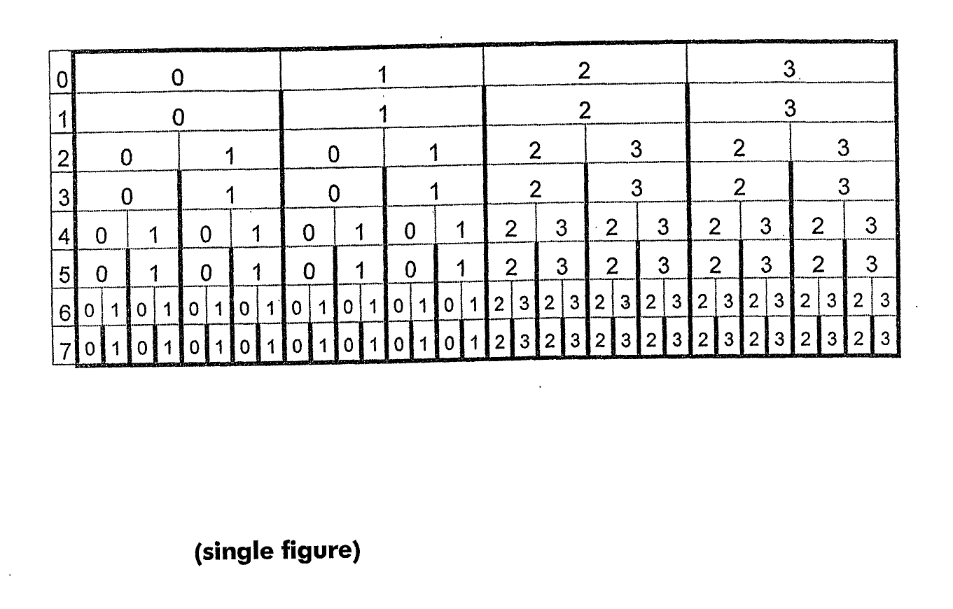

### BACKGROUND OF THE INVENTION

The invention relates to a method of operating a radio-based telecommunications system wherein the data to be transmitted are transmitted in data frames, so-called frames, wherein a plurality of frames are combined to form a group, wherein a format-related indicator is transmitted for each frame, and wherein a number of permissible format-related indicators is defined in advance. The invention likewise relates to a base station or a mobile station of a radio-based telecommunications system and to a receiver for a base station or mobile station of this kind.

The invention is based on a priority application of DE 101 17 628.7 which is hereby incorporated by reference.

### SUMMARY OF THE INVENTION

A prior art method of operating a radio-based telecommunications system is known for example from a UMTS telecommunications system (see Standard 3GPP, TS 25.302) wherein the data frames or frames have a time duration of 10 milliseconds. For example, eight frames can be combined to form a group. The so-called TFC indicator (TFC=transport format combination) is provided as format-related indicator, which for example can be zero if no speech is transmitted or one if speech is transmitted. The above options for the TFC indicator and their significance are defined in advance in a so-called setup process using a TFC set. This TFC set contains all the permissible options for the TFC indicators which are received together with the following frames.

In accordance with the standardized prior art procedure for a UMTS telecommunications system, it is necessary to compare the received TFC indicator for each frame with those TFC indicators which are permissible according to the TFC set. In this check there is a probability differing from zero that errors will occur. Such an error causes the TFC indicator to be erroneously detected, which in turn causes the entire format, in particular the decoding and/or demodulation of the received data, to be erroneously executed. The received data are thus irretrievably lost.

### OBJECT AND ADVANTAGES OF THE INVENTION

The object of the invention is to provide a method of the type referred to in the introduction wherein the probability of errors in the checking of the format-related indicators is reduced.

This object is achieved in a method of the kind referred to in the introduction, in accordance with the invention, in that the number of permissible format-related indicators is reduced as a function of the combination of data frames or frames in groups. The object is achieved in a corresponding manner in the case of a base station or mobile station of a radio-based telecommunications system and in the case of a receiver for such a base station or mobile station.

As a result of the reduction in the number of permissible format-related indicators, the probability of the occurrence of an error in the checking of the format-related indicators is at the same time reduced. The fewer format-related indicators are permitted, the fewer errors can occur in their checking. This is however synonymous with reducing the probability that the entire format, in particular the decoding and/or demodulation of the received data, is erroneously executed. The probability that received data are irretrievably lost is thus reduced and the quality of the entire telecommunications system is thus increased.

The reduction in the number of permissible TFC indicators according to the invention is achieved by taking into account the combination of data frames or frames in groups. If, in a UMTS telecommunications system, for example eight frames are combined to form a group, and if the TFC indicator of the first frame of this group is equal for example to zero, in accordance with the invention it is deduced that the TFC indicator of the next seven frames must likewise be equal to zero. Then, in accordance with the invention, only a TFC indicator which is equal to zero is permitted for these following seven frames. A TFC indicator equal to one is excluded for these following seven frames. This constitutes the above described reduction in the number of permissible format-related indicators, which itself leads to the explained reduction in error probability.

It is particularly advantageous to exclude, for a specific data frame or frame, those format-related indicators which must not occur at all in the specific frame due to the combination of frames in groups. Thus for a specific frame, the only format-related indicators specified as permissible are those which can in fact occur in the specific frame taking into account the combination of frames in groups. Thus in the case of a UMTS telecommunications system, the TFC set for the permissible TFC indicators is constantly changed, this TFC set always being limited to the minimum number of permissible TFC indicators. Those TFC indicators which cannot occur at all on the basis of the combination of frames in groups, are excluded from the TFC set in accordance with the invention. Thus, continuously, only the minimum permissible TFC indicators are present which—as explained—leads to a reduction in the error probability in the checking of these TFC indicators.

### BRIEF DESCRIPTION OF THE DRAWINGS AND OF EXEMPLARY EMBODIMENTS

Further features, possible applications and advantages of the invention will become apparent from the following description of exemplary embodiments of the invention and from the enclosed drawings (figure shows a data table). All the described features, independently or in any combination, form the subject of the invention irrespectively of their summarization in the claims or their dependencies and irrespective of their wording in the description.

In a UMTS telecommunications system (UMTS=universal mobile telecommunications system), control data are transmitted in a DPCCH channel (DPCCH=dedicated physical control channel) and the so-called payload, thus the data actually to be transmitted, are transmitted in a DPDCH channel (DPDCH=dedicated physical data channel) between a base station (so-called node B) and a mobile station (so-called UE=user equipment). The transmission of the control data and of the payload takes place in data frames, so-called frames, each having a length of 10 milliseconds. The term “frame” has been used in the following description, although it is synonymous with the term “data frame”.

Each frame of the DPCCH channel contains a so-called TFC indicator (TFC=transport format combination) which specifies how the information in the simultaneously transmitted payload of the DPDCH channel is to be interpreted. This TFC indicator gives, in particular, directions as to how the payload is to be demodulated and/or decoded. The frame incoming on the DPDCH channel is intermediately stored in each receiver, thus in the receiving node B or the receiving UE, until the frame incoming on the DPCCH channel with the TFC indicator contained therein has been read, whereupon the intermediately stored frame is interpreted with the aid of the read TFC indicator.

The TFC indicator contains i.a. information indicating whether a plurality of consecutive frames on the DPCCH channel and the DPDCH channel are combined to form a group. Here it is possible for two or four or eight frames to form such a group. These groups then have a corresponding length of 20 or 40 or 80 milliseconds. Furthermore such groups can only commence in a fixed time pattern. Thus 80-millisecond groups can only commence every 80 milliseconds, and correspondingly 40- and 20- millisecond groups can only commence every 40 and 20 milliseconds respectively.

The combination of frames in groups is defined in a so-called setup. Also transmitted in this setup is a TFC set indicating which TFC indicators are permitted for the following transmission.

If a frame containing control data is received by a receiver on the DPCCH channel, the receiver checks whether the TFC indicator contained therein is permissible, thus whether the obtained TFC indicator is contained in the TFC set transmitted in the setup. There is a probability differing from zero that this check will lead to an erroneous result.

As a function of the combination of frames in groups, specific TFC indicators can optionally be excluded from the TFC set. The number of possible TFC indicators in the TFC set is thereby reduced. This is synonymous with a reduced probability of an error occurring in the checking of the permissibility of the received TFC indicator.

In the following first example, which relates for example to the transmission of speech, it will be assumed that eight frames are combined to form a group which thus has a length of 80 milliseconds. This group can therefore only commence in the predetermined time pattern of 80 milliseconds. The predetermined TFC set contains the TFC indicators TFCI=0 and TFCI=1. TFCI=0 signifies that no payload is present and TFCI=1 signifies that a payload is present.

If a plurality of TFCIs=0 and then one TFCI=1 are now received in the receiver, it is checked whether the TFCI=1 belongs to a new group which commences correctly in the time pattern of 80 milliseconds. If this is not the case, an error is detected. If the TFCI=1 is received correctly in the time pattern for the 80 millisecond group, the TFCI=1 is permitted and further processed accordingly. In this case it is also specified that the next seven TFCIs must compulsorily also be equal to “1”. This is due to the fact that an 80 millisecond group always combines eight frames each of 10 milliseconds, which must therefore all possess one TFCI=1. The above specification is synonymous with reducing the TFC set for the following seven frames, and specifically by the possibility that TFCI=0. TFCI=0 is thus excluded in the TFC set for the next seven frames. For the next seven frames the TFC set thus only has the possibility that TFCI=1.

In the following second example it will be assumed that two data streams are present which are transmitted in multiplex operation. The first data stream is to relate to speech and the second data stream is to relate to a re-selection by a user. It is further assumed that in the case of the first data stream two frames are combined to form a group, whereas in the case of the second data stream eight frames are combined to form a group. This is synonymous with the fact that the first data stream can only ever commence in a time pattern of 20 milliseconds and the second data stream can only ever commence in a time pattern of 80 milliseconds.

This results in a TFC set as follows: TFCI=0 signifies no payload, thus neither speech payload nor selection payload, TFCI=1 signifies only speech payload, TFCI=2 signifies only selection payload, and TFCI=3 signifies speech- and selection payload.

The data table shown in the enclosed figure indicates the options which occur in the present second example.

In the narrow column on the outer left in the Table the consecutive frames are indicated by consecutive numbers, and specifically eight frames by the numbers “0” to “7”.

Now—as in the first example—it will be assumed that a plurality of TFCIs=0 have been received in the receiver, and that then one of those TFC indicators is received which is indicated by the number 0 in the first row and thus for the first frame. This can be a TFCI=0, a TFCI=1, a TFCI=2 or a TFCI=3. These four options are explained in detail in the following with reference to the Table.

TFCI=0 in the frame bearing the number 0, see fourth column from the right in the Table:

If a TFCI=0 is received in the frame bearing the number 0, this has the result that again only a TFCI=0 can arrive in the following frame bearing the number 1. This is due to the fact that one of the two data streams can only ever begin in a time pattern of either 20 milliseconds or 80 milliseconds. Thus it is impermissible for one of the two data streams to commence in the case of the frame bearing the number 1 which arrives after 10 milliseconds.

This specification, that only a TFCI=0 can be present in the frame bearing the number 1, is taken into account in that the TFC set is limited in this frame bearing the number 1. For this purpose the TFCI=1 is extracted from the TFC set in the said frame. The TFC set is thus reduced by this TFCI=1. This is also apparent from the Table in which, in the frame bearing the number 1, only the TFCI=0 is entered under the preceding TFCI=0 of the frame bearing the number 0.

In the frame bearing the number 2 there are only two options, and indeed either a TFCI=0 or a TFCI=1 can be received. This is due to the fact that the first data stream with the time pattern of 20 milliseconds can commence in this frame with the number 2, whereas the second data stream with the time pattern of 80 milliseconds cannot. Therefore a TFCI=2 or a TFCI=3, both of which always imply the second data stream, cannot arrive.

The TFC indicators to be received are thus again limited to the two above-mentioned options, thus to TFCI=0 and TFCI=1. This is also apparent from the Table in which, under the two TFCIs=0 of the first two frames bearing the numbers 0 and 1, only the TFCI=0 and the TFCI=1 are entered in the next frame with the number 2.

In the frame bearing the number 3, the TFC indicator again cannot change. In this respect the frame bearing the number 3 corresponds to the frame bearing the number 1. If the TFCI=0 was in the frame bearing the number 2, it must continue to be so in the frame bearing the number 3. Corresponding applies if the TFCI was 1. This is due to the fact that the first data stream can only commence in a time pattern of 20 milliseconds and that the frame bearing the number 3 does not belong to this time pattern.

The frame bearing the number 4 again fits into the time pattern of 20 milliseconds. For this reason the first data stream can commence here. This is irrespective of which TFC indicator was received in the frame bearing the number 3. To this extent the frame bearing the number 4 corresponds to the frame bearing the number 2. In both cases, i.e. if the TFCI=0 or the TFCI=1 was in the frame bearing the number 3, the TFCI=0 or TFCI=1 can be in the following frame bearing the number 4. This is also apparent from the Table.

It is important that, as also in the case of the previous frames, in the frame bearing the number 4 the number of possible TFC indicators is limited. Those TFC indicators which are not possible are extracted from the TFC set so that the TFC set is reduced in this respect.

In the following frames with the numbers 5, 6 and 7, again only the TFCI=0 or the TFCI=1 can ever occur. This is due to the fact that the second data stream with the time pattern of 80 milliseconds cannot commence in all these frames. Instead, either the first data stream with the time pattern of 20 milliseconds can be present, TFCI=1, or not present, TFCI=0. Further, this second data stream then is always either present or not present for two consecutive frames.

This described occurrence of TFCI=0 or TFCI=1 in the frames bearing the numbers 5, 6 and 7 can also be seen from the Table.

TFCI=1 in the frame bearing the number 0, see third column from the right in the Table:

If a TFCI=1 is received in the frame bearing the number 0, this means that the first data stream commences with the time pattern of 20 milliseconds. This has the result that again only a TFCI=1 can arrive in the following frame bearing the number 1. As already explained, this is due to the fact that the second data stream can only ever commence in a time pattern of 80 milliseconds. It is thus impermissible for the second data stream to commence in the case of the frame bearing the number 1, which arrives after 10 millisecond.

The same conditions as already described apply onwards from the frame bearing the number 2. In the following frames only the TFCI=0 or the TFCI=1 can ever occur. The TFCI=2 or the TFCI=3 cannot occur as this would imply the commencement of the second data stream. This commencement can however only take place in the time pattern of 80 milliseconds, which is not fulfilled in the case of the above mentioned frames.

As also already described, it is thus possible to reduce the TFC set accordingly in that the TFC set contains only those TFC indicators which can actually occur, thus in accordance with the above description only the TFCI=0 and/or the TFCI=1. The number of possible TFC indicators in the TFC set is thus reduced. This is synonymous with a reduced probability of an error occurring in the checking of the permissibility of the received TFC indicator.

TFCI=2 or TFCI=3 in the frame bearing the number 0, see second and first column from the right in the Table:

The TFCI=2 and the TFCI=3 in the frame bearing the number 0 signify that the second data stream commences. This has a length of 80 milliseconds and is thus present in eight consecutive frames. Consequently the following TFC indicators in the frames bearing the numbers 1 to 7 cannot be TFCI=0 or TFCI=1, as in the case of these TFC indicators the second data stream is not present. Instead, the TFC indicators in the frames bearing the numbers 1 to 7 must either be TFCI=2 or TFCI=3 as the second data stream is only present in the case of these TFC indicators. This is also apparent from the Table.

As mentioned, the TFC indicators in the frames bearing the numbers 1 to 7 can only be TFCI=2 or TFCI=3 if the TFCI=2 or the TFCI=3 is received in the frame bearing the number 0. Which of the two said TFC indicators is permissible is again apparent from the Table. This is dependent upon whether the first data stream commences in addition to the second data stream in one of the frames bearing the numbers 0, 2, 4 or 6. If this is the case, the TFCI=3 is present at least for two consecutive frames. The two consecutive frames are based on the fact that the first data stream has a time pattern of 20 milliseconds so that the second data stream always at least covers two consecutive frames.

As likewise already described, it is thus possible to reduce the TFC set accordingly in that the TFC set contains only those TFC indicators which can actually occur, thus in accordance with the above description, only the TFCI=2 and/or the TFCI=3. The number of possible TFC indicators in the TFC set is thus reduced. This is synonymous with a reduced probability of an error occurring in the checking of the permissibility of the received TFC indicator.

When all eight frames shown in the Table have been received, any TFC indicator can occur again, thus the TFCI=0, the TFCI=1, the TFCI=2 and the TFCI=3. This corresponds to the frame bearing the number 0 in the Table. In this respect it is possible to re-use the table, and in particular the limitations shown in the Table for the possible TFC indicators of the TFC set in a corresponding fashion. It is thus continuously possible to limit the indicators of the TFC set, which is synonymous with a reduced probability of an error occurring in the checking of the permissibility of the received TFC indicator.

1. A method of operating a radio-based telecommunications system, in particular a UMTS telecommunications system, wherein the data to be transmitted are transmitted in data frames, so-called frames, wherein a plurality of data frames are combined to form a group, wherein a format-related indicator is transmitted for each data frame, and wherein a number of permissible format-related indicators is specified in advance, and wherein the number of permissible format-related indicators is reduced as a function of the combination of data frames in groups.

2. A method according to claim 1, wherein, for a specific data frame, those format-related indicators are excluded which cannot occur at all in the specific data frame on the basis of the combination of data frames in groups.

3. A method according to claim 1, wherein, for a specific data frame, only those format-related indicators are specified as permissible which can actually occur in the specific data frame taking into account the combination of data frames in groups.

4. A receiver for a base station or for a mobile station of a radio-based telecommunications system, in particular a UMTS telecommunications system, wherein the data to be transmitted are transmitted in data frames, so-called frames, wherein a plurality of data frames are combined to form a group, wherein a format-related indicator is transmitted for each data frame, wherein a number of permissible format-related indicators is specified in advance, and wherein in the receiver means are provided with which the number of permissible format-related indicators is reduced as a function of the combination of data frames in groups.

5. A base station or mobile station for a radio-based telecommunications system, in particular for a UMTS telecommunications system, wherein the data to be transmitted are transmitted in data frames, so-called frames, wherein a plurality of data frames are combined to form a group, wherein a format-related indicator is transmitted for each data frame, wherein a number of permissible format-related indicators is specified in advance, and wherein means are provided with which the number of permissible format-related indicators is reduced as a function of the combination of data frames in groups.
